(19) United States
(12) Patent Application Publication
(10) Pub. No.: US 2013/0324088 A1
(43) Pub. Date: Dec. 5, 2013

(54) COMMUNICATION DEVICE, METHOD AND VEHICLE

(71) Applicant: GM GLOBAL TECHNOLOGY OPERATIONS LLC, Detroit, MI (US)

(72) Inventor: Frank JORDAN, Ruesselsheim (DE)

(73) Assignee: GM GLOBAL TECHNOLOGY OPERATIONS LLC, Detroit, MI (US)

(21) Appl. No.: 13/798,362

(22) Filed: Mar. 13, 2013

(30) Foreign Application Priority Data
Jun. 5, 2012 (DE) 10 2012 011 151.7

(51) Int. Cl. H04W 12/06

(52) U.S. Cl. CPC H04W 12/06
USPC 455/411

(57) ABSTRACT

The present invention relates to a communication device, in particular in a vehicle or for a vehicle, with a detection unit configured to automatically detect the presence of at least one mobile electronic device in the environment of the communication device, with an interrogator configured to automatically request an input from a user, the input comprising permitting or denying the communication with one of the detected mobile electronic devices, and with a control unit configured to establish a communication connection with the corresponding detected mobile electronic device as a function of the requested input. The present invention also comprises a method and a vehicle.

### CROSS-REFERENCE TO RELATED APPLICATION

This application claims priority to German Patent Application No. 10 2012 011 151.7, filed Jun. 5, 2012, which is incorporated herein by reference in its entirety.

### TECHNICAL FIELD

The technical field relates generally to a communication device, and particularly a communication device in a vehicle or for a vehicle. Furthermore, the technical field relates to a corresponding method as well as to a vehicle.

### BACKGROUND

Although the various embodiments are described below in the context of mobile telephones, sometimes called mobile phones in the following, it is applicable to any mobile communication device.

Many people nowadays consider it a fundamental requirement to be reachable wherever they are. In particular, in a commercial environment it is generally an absolute necessity to be reachable at any time and in any place. For this reason mobile telephones are in widespread use. In many countries and regions the use of mobile phones, however, may be subject to legal restrictions, for example. As such it can be forbidden to use a mobile phone while driving a motor vehicle.

For this reason modern mobile phones comprise a hands-free function. Such hands-free units normally comprise an integrated microphone and an integrated loudspeaker or a headset. In addition there exist Bluetooth-based hands-free units thus bypassing the need for a connecting cable. Also modern vehicles may comprise hands-free units in order to enable the driver to make a call while driving without having to use the mobile phone. Such a hands-free unit may, for example, be integrated in an existing vehicle information system, such as an infotainment system or a head-up-unit.

If a mobile phone is to be coupled to a cable-less hands-free unit, a user of the hands-free unit must manually initiate a search operation with which all mobile phones within reach of the hands-free unit are identified. The user can then select with which of the mobile phones he wants to couple the hands-free unit.

With hands-free units which are integrated in an existing vehicle system, this coupling operation is cumbersome and sometimes confusing, since the user is guided through a menu and various submenus of the vehicle information system. Frequently there are also restrictive conditions governing the coupling of a mobile telephone with the hands-free unit. In some vehicles, for example, a mobile phone can only be coupled with a hands-free unit when the ignition of the vehicle is switched on, but the engine of the vehicle has not yet been started. This can result in a user who is not familiar with the respective vehicle and the respective vehicle information system being unsuccessful in getting the mobile phone coupled with the hands-free unit.

It is therefore desirable to provide a means that simplifies coupling of a mobile phone with a vehicle. In addition, other objects, desirable features and characteristics will become apparent from the subsequent summary and detailed description, and the appended claims, taken in conjunction with the accompanying drawings and this background.

### SUMMARY

In an exemplary embodiment, a communication device, in particular in a vehicle or for a vehicle, contains a detection unit configured to automatically detect a mobile electronic device in the environment of the communication device, an interrogator configured to automatically request an input from the user for permitting or denying communication with one of the detected mobile electronic devices, and a control unit configured to establish a communication connection with the corresponding detected mobile electronic device as a function of the requested input.

A method for communicating data, in particular for a vehicle or in a vehicle, for execution with a communication device according to an embodiment includes the steps of automatically detecting the existence of at least one mobile electronic device in the environment of the communication device, requesting an input from a user, permitting or denying the communication with the respective detected mobile electronic device, and establishing a communication connection with the detected mobile electronic device as a function of the requested input.

A vehicle, for example, an automobile, with a communication device according to an embodiment also is provided.

The knowledge on which the various embodiments are based consists in that a user tends to change his/her mobile electronic device rather infrequently and normally uses it over an extended period of time, for example, one or two years. In recognition of this knowledge, a communication device, which makes it easy for a user of the communication device to use his/her mobile electronic device with the communication device, is thus provided herein.

To this end, in an embodiment, the communication device automatically detects mobile electronic devices in its environment and indicates to the user the possibility that he can select one or none of the detected mobile electronic devices with which to communicate. To this end a control unit is also provided which controls the communication between the communication device and the mobile electronic device corresponding to the selection made by the user.

In one embodiment the interrogator is configured not to request an input from the user until the respective detected mobile electronic device has been detected for a specified period of time. If a period of time is specified within which the mobile electronic device must be detected before requesting the input from a user, it can be effectively prevented that input requests are indicated to the user relating to mobile electronic devices which are only temporarily or accidentally within the environment of the communication device. This may be the case, for example, at a traffic light or in a car park frequented by many people, where, of course, a large number of mobile devices happen to be in the environment of the communication device. This considerably simplifies the process of permitting a communication between the communication device contemplated herein and a mobile electronic device.

In one embodiment the interrogator is configured to request an input from a user when the respectively detected mobile electronic device is detected during a movement of the communication device over a specified distance. If a distance is specified in which a mobile electronic device must be detected during a movement of the communication device before an input is requested from a user, it can be effectively prevented that an input request is indicated to the user also for mobile electronic devicesthat are only temporarily or accidentally in the environment of the communication device. This is advantageous, in particular when using the communication device in a private car or a truck. For it can thereby be prevented that an input request for each detected mobile electronic device is indicated to the user for example at a traffic light or in a car park frequented by many people. This considerably simplifies the process of permitting a communication between the communication device contemplated herein and a mobile electronic device.

In one embodiment the interrogator is configured to request an input from the user when the respectively detected mobile electronic device was detected during two operating cycles of the communication device. If for example it is specified that a mobile electronic device is to be detected within at least two operating cycles of the communication device before the input is requested from the user, it can be effectively prevented that an input request is indicated to the user for mobile electronic devices that are only temporarily or accidentally in the environment of the communication device. This can be the case, for example, at a traffic light or in a car park frequented by many people. This considerably simplifies the process of permitting a communication between the communication device contemplated herein and a mobile electronic device.

In a further embodiment a combination of the above-mentioned conditions for requesting an input from a user may be utilized. In one embodiment, for example, an input request may be presented to a user when a mobile electronic device was detected within two operating cycles of the communication device for at least 10 minutes, respectively, while the communication device was moved by at least 5 kilometers. The named values—2 operating cycles, 10 minutes and 5 kilometers—(which here are to be understood as examples only) can be applied in different embodiments in different ways.

In one embodiment a memory is provided which is configured to store an identifier of the detected mobile electronic devices and/or the corresponding inputs requested from the user.

In one embodiment the control unit is configured to check, when detecting one of the mobile electronic devices, whether an input is stored in the memory for the corresponding detected mobile electronic device and, if this is stored, to establish a communication connection with the detected mobile electronic device as a function of the stored input. This makes it possible to re-use input requests from the user in further operating cycles of the communication device without having to request these again from the user.

In one embodiment a Bluetooth interface for communication with the detected mobile electronic device is provided, for which the requested input comprises a permission. This makes it possible to couple the communication device contemplated herein with a plurality of mobile electronic devices.

In one embodiment the control unit is configured to transmit, via the Bluetooth interface, digital data and/or audio data to the detected mobile electronic devices and/or receive these from them, for which the requested input comprises a permission. This makes it possible to use the communication device contemplated herein, for example, as a hands-free unit for mobile telephones.

The above and further embodiments can be randomly combined with each other, provided the combination is meaningful. Further possible designs, further developments and implementations also include not explicitly mentioned combinations of previously described features or features described hereunder with reference to the exemplary embodiments. In particular, the expert would add individual aspects which are improvements or amendments to the respective basic form of the embodiments.

### BRIEF DESCRIPTION OF THE DRAWINGS

The various embodiments will hereinafter be described in conjunction with the following drawing figures, wherein like numerals denote like elements, and wherein:

FIG. 1 shows a circuit diagram of a communication device according to an exemplary embodiment;

FIG. 2 shows a flow diagram of a method for communicating data according to an exemplary embodiment;

FIG. 3 shows a schematic diagram of a vehicle according to an exemplary embodiment; and

FIG. 4 shows a circuit diagram of a communication device according to another exemplary embodiment.

### DESCRIPTION OF EXEMPLARY EMBODIMENTS

The following detailed description is merely exemplary in nature and is not intended to limit the various embodiments or the application and uses thereof Furthermore, there is no intention to be bound by any theory presented in the preceding background or the following detailed description.

FIG. 1 shows a circuit diagram of a communication device 1 according to an exemplary embodiment.

The communication device 1 shown in FIG. 1 comprises a detection unit 2 for detecting one or more mobile electronic devices 3 in an environment of the communication device 1. The detection unit 2 is coupled with an interrogator 4 which automatically requests an input 5 from the user. The input enables the user to permit or deny the communication with one of the detected mobile electronic devices 3.

The interrogator 4 is coupled with a control unit 6 and passes the user's input onto it. The control unit 6 establishes a communication connection 7 with the respective detected mobile electronic device 3 if the user's input comprises a permission for communicating with the detected mobile electronic device 3.

In one embodiment the interrogator 4 is configured not to request the input 5 from a user until specified conditions have been met. In one embodiment the specified conditions may relate to the detection of the mobile electronic devices 3.

In one embodiment for example, a condition for requesting an input relating to a respective mobile electronic device 3 may consist in that the respective mobile electronic device 3 is detected for a specified period of time.

In another or additional embodiment the condition for requesting an input relating to a respective mobile electronic device 3 may consist in that the respective mobile electronic device 3 is detected when the communication device is detected over a specified distance, for example over a distance of about lkm to about 50 km, for example, about 5 km to about 20 km, such as about 10 km.

In yet a further embodiment a condition for requesting an input to a respective mobile electronic device 3 may consist in that the respective mobile electronic device 3 is detected during two operating cycles of the communication device 1.

In a further embodiment the condition for requesting an input relating to a respective mobile electronic device 3 may be that the respective detected mobile electronic device 3 is detected during two successive operating cycles of the communication device 1.

In yet a further embodiment a condition for requesting an input relating to a respective mobile electronic device 3 may be that the respective detected mobile electronic device 3 is detected during two operating cycles of a preset number of operating cycles of the communication device 1. For example, it may be specified that the respective detected mobile electronic device 3 must be detected in at least two of ten operating cycles, for example, ten successive operating cycles.

In one further embodiment all or individual ones of the above-mentioned conditions can be combined with each other.

The detection unit 2 in FIG. 1 is configured as a Bluetooth host 2, which detects the presence of mobile electronic devices 3 in its environment. Further the interrogator 4 may be configured as a user interface 4, for example a touch-screen 4, on which a query can be displayed to a user and on which the user can provide his input 5. For example, the interrogator 4 may be configured as a system component of a vehicle infotainment system, such as as a screen or touch-screen of a vehicle infotainment system.

The control unit 6 may be configured as a micro-controller 6, micro-computer, processor etc.

In one embodiment the detection unit 2, the interrogator 4 and the control unit 6 may be configured as computer program products, which are executed on a processor of a computer system. For example, the computer program product may be implemented as a software component in a head unit of a motor vehicle.

Finally the mobile electronic device may be any mobile device which is able to establish a communication with the device contemplated herein. For example, these may be mobile portable Bluetooth-enabled electronic devices, such as mobile phones, smart phones, laptop computers, tablet PCs etc.

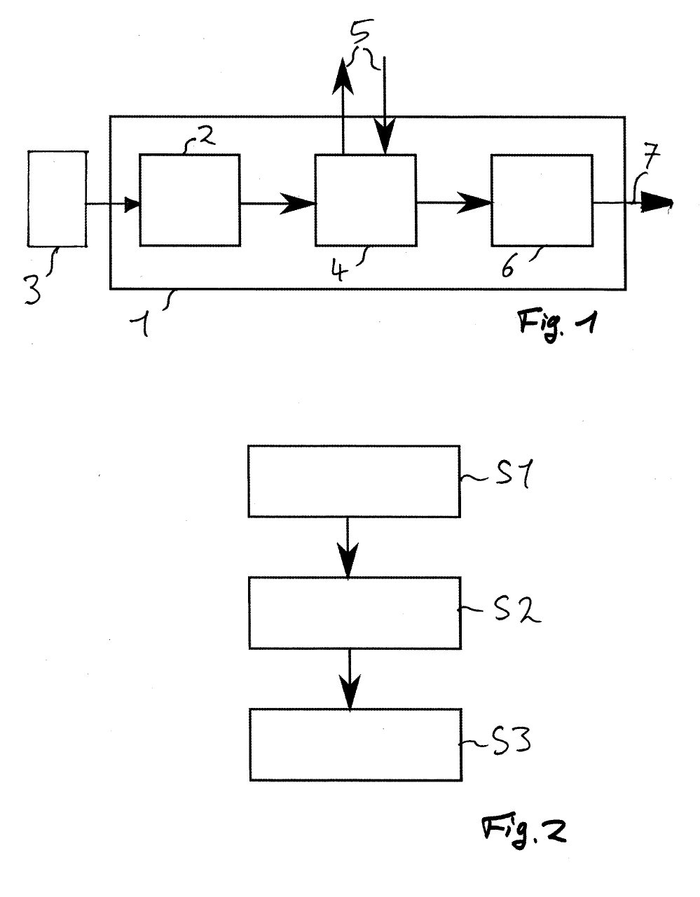

FIG. 2 shows a flow diagram of a method for communicating data according to an embodiment. With the method for communicating data, such as for a vehicle or in a vehicle, in a first step S1 the presence of at least one mobile electronic device 3 is automatically detected in the environment of the communication device 1. Further, in a second step S2 an input 5 is requested from a user. This request includes permitting or denying the communication with the respective detected mobile electronic device 3. Finally, in a third step S3, a communication connection 7 with the detected mobile electronic device 3 is established as a function of the requested input 5.

In one embodiment the step of requesting S2 is not performed until the specified conditions have been met.

The specified conditions in one embodiment may relate to detecting the mobile electronic devices 3.

In one embodiment, for example, a condition for requesting an input relating to a respective mobile electronic device 3 may consist in that the respective mobile electronic device 3 is detected for a specified period of time.

In one embodiment a condition for requesting an input to a respective mobile electronic device 3 may consist in that the respective mobile electronic device 3 is detected over a specified distance, for example over a distance of about lkm to about 50 km, for example about 5 km to about 20 km, such as about 10 km.

In yet another embodiment a condition for requesting an input relating to a respective mobile electronic device 3 may be that the respective detected mobile electronic device 3 is detected in at least two operating cycles of a preset number of operating cycles of the communication device 1.

Further or modified conditions are also possible.

In a further embodiment all or individual ones of the above-mentioned conditions can be combined with each other. In this case it is not mandatory that all combined conditions are met. Rather a two-out-of-three selection may be made. In addition to a selection of conditions there may be a single superior condition which by itself is sufficient to perform a request S2 for input.

In a further embodiment an identifier of the mobile electronic device 3 and the corresponding inputs 5 requested from the user are stored. When a mobile electronic device 3 is detected it is checked, whether an input 5 has been stored in the memory 8 relating to the detected mobile electronic device 3, and if this has been stored, whether a communication connection 7 with the detected mobile electronic device 3 is being established as a function of the stored input 5. This means that a user, following an input 5 relating to a mobile electronic device 3 is not requested a second time to make an input 5, if he has done so once.

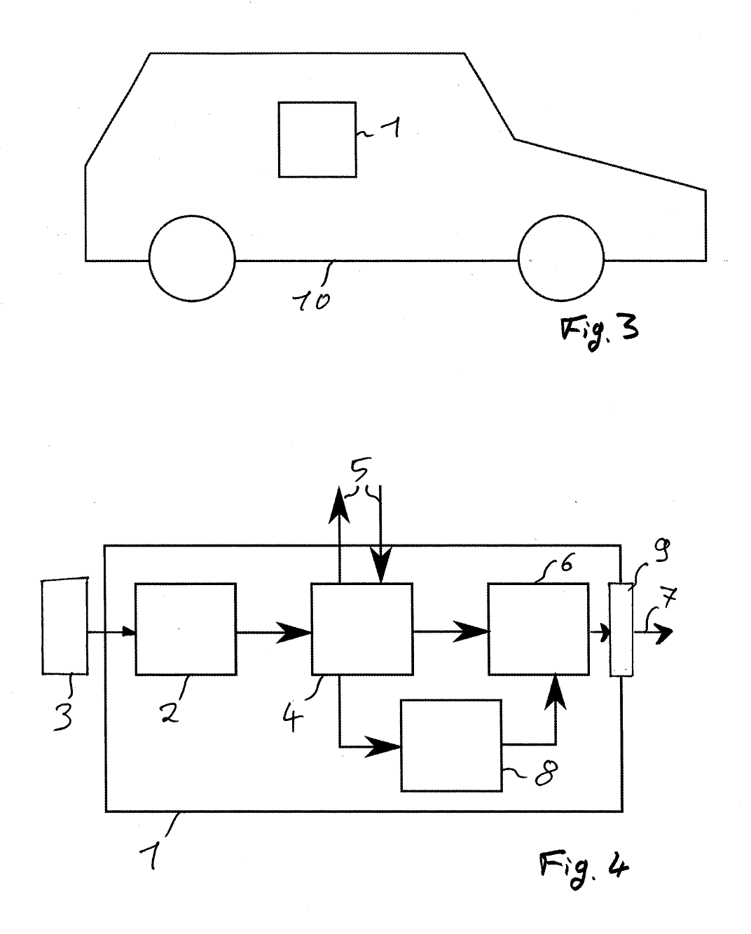

FIG. 3 shows a schematic diagram of a vehicle 10 according to an embodiment. The vehicle 10 in FIG. 3 comprises a communication device 1 as contemplated herein. The vehicle 10 in FIG. 3 is shown as a private car. But in further embodiments the vehicle 10 may also be a truck, a bus, a rail vehicle, an aircraft, a water craft etc.

FIG. 4 shows a circuit diagram of a further embodiment of a communication device 1. The communication device 1 in FIG. 4 is based on the communication device 1 in FIG. 1.

The communication device 1 in FIG. 4 additionally comprises a memory 8, in which the interrogator 4 stores inputs 5 of the users and checks with the aid of the interrogator 4 whether an input 5 of a user relating to a detected mobile electronic device 3 has already been stored. The memory 8 is also coupled with the control unit 6.

The control unit 6 is configured, provided an input 5 relating to a detected mobile electronic device 3 has already been stored, to establish, as a function of the stored input 5, a communication connection 7 to a corresponding mobile electronic device 3 via a Bluetooth interface 9.

This has the effect of preventing that a user is repeatedly bothered with a query relating to, for example, a certain mobile phone, although he had already made that input. This is, for example, of advantage for a vehicle which is shared between several people. If, for example the same persons always travel to work in a vehicle, the owner of the vehicle may grant permission for communication for his own mobile phone. For the mobile phone of a colleague of the owner, the owner can deny the permission. By storing these inputs the owner of the vehicle does not have to repeat this input.

Although the communication device has been described by way of exemplary embodiments, it is not limited thereto but can be modified in many different ways. In one embodiment a device for the communication of data, in particular for a vehicle or in a vehicle, includes means for automatically detecting S1 the presence of at least one mobile electronic device 3 in the environment of the communication device; and means for requesting S2 an input 5 from a user, the input comprising permitting or denying the communication with the respective detected mobile electronic device 3; and means for establishing S3 a communication connection 7 with the detected mobile electronic device 3 as a function of the requested input 5.

In one embodiment a device according to the previous embodiment is provided, wherein the input 5 is requested from a user if the detected mobile electronic device 3 is detected for a specified period of time.

In one embodiment a device according to one of the previous embodiments is provided, wherein the input 5 is requested from a user if the detected mobile electronic device 3 is detected while the communication device is moved over a specified distance.

In one embodiment a device according to one of the previous embodiments is provided, wherein the input 5 is requested from a user, if the respective detected mobile electronic device 3 is detected in at least two operating cycles of a preset number of operating cycles of the communication device.

In one embodiment a device according to one of the previous embodiments is provided, comprising means for storing an identifier of the mobile electronic devices 3 and the corresponding inputs 5 requested from the user.

In one embodiment a device according to the previous embodiment is provided, comprising means for checking during detecting a mobile electronic device 3, whether an input 5 relating to the detected mobile electronic device 3 has been stored in the memory 8, and if this is the case, for establishing a communication connection 7 with the detected mobile electronic device 3 as a function of the stored input 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A communication device in a vehicle or for a vehicle, comprising:
a detection unit which is configured to automatically detect the presence of at least one mobile electronic device in the environment of the communication device;
an interrogator which is configured to automatically request from a user an input comprising permitting or denying the communication with one of the detected devices; and
a control unit which is configured to establish a communication connection with the corresponding detected device as a function of the requested input.

2. The device according to claim 1, wherein the interrogator is configured not to request the input from a user until the respective detected device has been detected for a specified period of time.

3. The device according to claim 1 wherein the interrogator is configured not to request the input from a user until the respective detected device has been detected for a movement of the communication device over a specified distance.

4. The device according to claim 1 wherein the interrogator is configured not to request the input from a user until the respective detected device has been detected at least during two operating cycles of the communication device.

5. The device according to claim 1 wherein a memory is provided, which is configured to store an identifier of the detected devices and/or the corresponding inputs requested from the user.

6. The device according to claim 5, wherein the control unit is configured to check during detection of one of the devices, whether an input has been stored in the memory relating to the corresponding detected device, and if this input has been stored, to establish a communication connection with the detected device as a function of the stored input.

7. The device according to claim 6 wherein a Bluetooth interface is provided for communication with the devices, for which the requested input comprises a permission.

8. The device according to claim 7, wherein the control unit is configured to communicate to, or receive from, the detected devices at least one of digital data and audio data via the Bluetooth interface, if the requested input for these devices comprises a permission.

9. A data communication method for a vehicle or in a vehicle, for execution with a communication device, comprising:
automatically detecting the presence of at least one mobile electronic device in the environment of a communication device;
requesting an input from a user, which input comprises permitting or denying the communication with the respective detected device; and
establishing a communication connection with the detected mobile electronic device as a function of the requested input.

10. The method according to claim 9, wherein the input from a user is not requested, until the device has been detected for a specified period of time.

11. The method according to claim 9, wherein the input from a user is not requested, until the device has been detected during a movement of the communication device over a specified distance.

12. The method according to claim 9, wherein the input from a user is not requested, until the respected detected device has been detected at least during two operating cycles of the communication device.

13. The method according to claim 9, wherein at least one of identifiers of the detected devices and the corresponding inputs requested from the user are stored.

14. The method according to claim 13, wherein during detection of a device it is checked whether a corresponding input has been stored in the memory for the detected device, and if this has been stored, a communication with the detected device is established as a function of the stored input.

15. A motor vehicle, comprising:
at least one communication device including:
a detection unit which is configured to automatically detect the presence of at least one mobile electronic device in the environment of the communication device;
an interrogator which is configured to automatically request from a user an input comprising permitting or denying the communication with one of the detected devices; and
a control unit which is configured to establish a communication connection with the corresponding detected device as a function of the requested input,
wherein the interrogator is configured not to request the input from a user until the respective detected device has been detected for a specified period of time.
